(19) United States
(12) Patent Application Publication
(10) Pub. No.: US 2012/0097659 A1
(43) Pub. Date: Apr. 26, 2012

(54) HONEYCOMB BODY HEATABLE IN MULTIPLE STAGES, METHOD FOR HEATING A HONEYCOMB BODY AND MOTOR VEHICLE

(75) Inventors: THORSTEN DUESTERDIEK, HANNOVER (DE); RICHARD DORENKAMP, BERLIN (DE); THOMAS NAGEL, ENGELSKIRCHEN (DE); JAN HODGSON, TROISDORF (DE); SVEN SCHEPERS, TROISDORF (DE); CARSTEN KRUSE, TROISDORF (DE)

(73) Assignee: EMITEC GESELLSCHAFT FUER EMISSIONSTECHNOLOGIE MBH, LOHMAR (DE)

(21) Appl. No.: 13/279,441

(22) Filed: Oct. 24, 2011

Related U.S. Application Data
(63) Continuation of application No. PCT/EP2010/055163, filed on Apr. 20, 2010.

(30) Foreign Application Priority Data
Apr. 22, 2009 (DE) 10 2009 018 182.2

(51) Int. Cl. H05B 1/00; H05B 3/06

(52) U.S. Cl. 219/202; 219/520

(57) ABSTRACT

An electrically heatable honeycomb body includes channels and at least one heating disk having at least one first and one second layer stack of electrically conductive material. The first and second layer stacks are interleaved with and electrically insulated from each other. The first layer stack forms a first current path for conducting an electrical current for a first heating circuit and the second layer stack forms a second current path for conducting an electrical current for a second heating circuit. The first heating circuit operates at a power of 300 W to 500 W and the second heating circuit operates at 500 W to 700 W. Exhaust gas of an internal combustion engine can be evenly heated by several independent heating circuits in a common heating disk even with different heating capacities using a simple construction. A method for heating a honeycomb body and a motor vehicle are provided.

### CROSS-REFERENCE TO RELATED APPLICATION

This is a continuation, under 35 U.S.C. §120, of copending International Application No. PCT/EP2010/055163, filed Apr. 20, 2010, which designated the United States; this application also claims the priority, under 35 U.S.C. §119, of German Patent Application DE 10 2009 018 182.2, filed Apr. 22, 2009; the prior applications are herewith incorporated by reference in their entirety.

### BACKGROUND OF THE INVENTION

### Field of the Invention

The present invention relates to an electrically heatable honeycomb body, through which a fluid, in particular an exhaust gas, can flow. Moreover, the invention also relates to a motor vehicle having a corresponding heatable honeycomb body and to a method for heating a honeycomb body.

Honeycomb bodies of that kind are often used as a contact surface for heating fluids and sometimes also as carrier bodies for catalysts intended for the catalytic conversion of reactive components of fluids. One significant area of application for such electrically heatable honeycomb bodies having catalysts (possibly downstream in the direction of flow) is the catalytic cleaning of exhaust gases from internal combustion engines, especially from internal combustion engines in motor vehicles. In that case, the catalytically coated honeycomb bodies are used in the exhaust system of the internal combustion engines and exhaust gases arising during the operation of the internal combustion engines flow through them.

Catalytic converters usually develop their catalytic action only above a certain “light off temperature.” In the case of catalytic converters used to convert pollutants in exhaust gases from conventional internal combustion engines, the light off temperatures are often a few hundred degrees Celsius (e.g. about 250° C.). In order to achieve its catalytic activity as early as possible or to maintain its activity during operation, such a catalytic converter must therefore be heated, especially during the starting phase of an internal combustion engine, during which the combustion exhaust gases are often at a comparatively low temperature.

A heatable honeycomb body, which is constructed from two disks, is known from International Publication No. WO 92/13636 A1, corresponding to U.S. Pat. Nos. 5,525,309; 5,382,774 and 5,370,943, for example. Those two disks of the honeycomb body are spaced apart and connected to each other with the aid of supports. That embodiment makes it possible to construct a first disk for rapid heating by conducting electric current therethrough. That disk has a plurality of heating zones, which are connected electrically in series. As a result, it is not possible to heat particular zones selectively with different heating powers of the honeycomb body.

### SUMMARY OF THE INVENTION

It is accordingly an object of the invention to provide a honeycomb body heatable in multiple stages, a method for selectively heating a honeycomb body with different heating powers and a corresponding motor vehicle, which overcome the hereinafore-mentioned disadvantages and at least partially solve the highlighted problems of the heretofore-known devices, methods and vehicles of this general type and, in particular, to specify a honeycomb body which can be heated in multiple stages and has a plurality of heating circuits with heating powers which can be controlled independently of each other, preferably also with a possibility of uniform heating of a fluid over an inflow cross section or a uniform introduction of heat into the fluid over the inflow cross section.

With the foregoing and other objects in view there is provided, in accordance with the invention, an electrically heatable honeycomb body, comprising channels and at least one heating disk having at least one first layer stack of an electrically conductive material and one second layer stack of an electrically conductive material. The first layer stack and the second layer stack are twisted with each other and electrically insulated from each other. The first layer stack forms a first current path for conducting an electrical current for a first heating circuit and the second layer stack forms a second current path for conducting an electrical current for a second heating circuit.

As mentioned above, the electrically heatable honeycomb body has at least one heating disk with at least one first layer stack and one second layer stack. The first layer stack and the second layer stack are preferably constructed from smooth layers and/or structured layers, which form flow channels (that run substantially parallel to each other). For this purpose, the smooth layers and/or the structured layers are layered one above the other, with any desired combination of smooth layers and/or structured layers principally being possible. These smooth and structured layers are made of an electrically conductive material, especially metal or metal foil, and can have a coating. This coating can, in particular, be a catalytically activated washcoat, which increases the surface area and catalytic activity through its porous structure.

The first layer stack and the second layer stack are preferably folded along a first fold and a second fold. This first fold and second fold extend substantially parallel to the center line of the honeycomb body. By virtue of the folding (bending, deflection etc.), the first layer stack has two layer arms starting from the first fold, and the second layer stack has two layer arms starting from the second fold. These layer arms are electrically insulated from each other (through the use of an air gap, for example). In other words, this means that a current across the two layer arms of a layer stack can flow only through the respective fold of the layer stack.

The folded first layer stack and the folded second layer stack are twisted with each other, preferably in an S shape, with the first fold of the first layer stack and the second fold of the second layer stack preferably being disposed in the region or in the vicinity of the center line of the honeycomb body. Moreover, the length of the inflow side of the first layer stack and the length of the second layer stack are longer than the diameter of the honeycomb body. In particular, this has the effect that the layer stacks do not span the diameter of the honeycomb body in a straight line but are curved in this plane (possibly several times). The “twisted” configuration is obtained, for example, by virtue of the fact that the layer stacks follow each other (with a constant spacing) in these curved sections too, or extend parallel to each other in one plane there too. An “outward bulge” of the first stack thus follows an “inward bulge” of the second stack and vice versa. The curved profile can also be distinguished, in particular, by the fact that each layer stack touches or intersects the diameter (i.e. a line through the geometric center of the honeycomb body in the (common) plane in which the layer stacks extend) several times.

The first layer stack and the second layer stack are electrically insulated from each other. It is thereby possible to have heating circuits that can be operated independently of each other in one disk or plane. The first layer stack is electrically connected to a first current source, and the second layer stack is electrically connected to a (distinct or spatially separated) second current source, with the result that the first layer stack forms a first current path for conducting an electric current for a first heating circuit, and the second layer stack forms a second current path for conducting an electric current for a second heating circuit. By virtue of the fact that the first layer stack and the second layer stack are twisted around one another, the first heating circuit and the second heating circuit are distributed substantially in the same way over the front face of the honeycomb body. This means, in particular, that the honeycomb body can be heated in a substantially uniform manner over its front face, both by the first heating circuit and also, separately, by the second heating circuit. Moreover, the heating power of the first heating circuit and the heating power of the second heating circuit can be monitored and adjusted, preferably independently of each other, through the use of the first current source and the second current source.

In principle, the heating disk is not restricted to two heating circuits. The heating disk can also have more than two layer stacks, which form more than two independent heating circuits by virtue of respective separate current sources. It is, of course, also possible for at least some of the heating circuits to employ a common negative electrode (common negative pole or common electric ground).

In accordance with another feature of the invention, the first layer stack and the second layer stack each have layers, and the layer thicknesses thereof are selected in such a way as to be different from each other. The term “layer thickness” in this case is intended to mean the thickness of the electrically conductive material, in particular metal or metal foils, of the layers. In principle, it is possible for all of the layers of a layer stack to have various (equal or different) layer thicknesses as compared with all of the layers of another layer stack, but this can also apply to just some of the layers. The layers of the individual layer stacks can thereby be advantageously constructed for the required heating powers of the individual heating circuits.

In accordance with a further feature of the invention, the layer thicknesses of the layers of the first layer stack are 25 μm [micrometers] to 35 μm, preferably substantially 30 μm, and the layer thicknesses of the layers of the second layer stack are 35 μm to 65 μm, preferably substantially 40 μm to 50 μm. It is preferred in this case that all of the layers of the first layer stack should have an (equal) first layer thickness and that all of the layers of the second layer stack should have an (equal) second layer thickness.

In accordance with an added feature of the invention, the number of layers of the first layer stack differs from the number of layers of the second layer stack. In this way, the individual layer stacks can be constructed in an advantageous manner for the required heating powers of the respective heating circuits.

In accordance with yet another feature of the invention, the layers of the first layer stack and the layers of the second layer stack have at least different structures or coatings. By way of example, the channel density obtained may be cited as a measure of the different structures, which may be in the range of 160 cpsi to 600 cpsi, for example. These structures can be holes, for example, or other devices for influencing the current flow and/or the heating power, at least in partial areas of the heating disk.

With the objects of the invention in view, there is also provided a method for heating a honeycomb body. The method comprises operating the first heating circuit of the heating disk at a power of 300 W [watts] to 500 W, preferably 350 W to 450 W, particularly preferably substantially 400 W, and operating the second heating circuit of the heating disk at 500 W to 700 W, preferably 550 W to 650 W, particularly preferably substantially 600 W.

It should, of course, be pointed out that the powers of the respective heating circuit can also be matched to the existing on-board electrical systems. Thus, electric powers of 1000 to 2000 W per heating circuit are also possible, depending on the application (passenger vehicle/truck—12 V/24 V).

With the objects of the invention in view, there is concomitantly provided a motor vehicle, comprising at least one honeycomb body according to the invention, which is configured to carry out the method according to the invention.

In a particularly preferred embodiment, an electrically heatable honeycomb body configuration has a support catalytic converter (disposed downstream in the direction of flow of the fluid (exhaust gas)) with a flow channel density of 300 to 600 flow channels per square inch (cpsi), a foil thickness of 40 micrometers and an axial support catalytic converter height of 120 mm. Support for the heating disk on the front face is provided by a multiplicity of (electrically insulated) support pins. Both substrate structures are disposed in a common housing.

The first layer stack of the heating disk has a flow channel density of 600 flow channels per inch², a foil thickness of 30 μm, an axial heating disk height of about 7 mm, 5 layers and a power of about 390 watts. The second layer stack of the heating disk has a flow channel density of 600 cpsi, a foil thickness of 40 μm, an axial heating disk height of about 7 mm, 6 layers and a heating power of about 600 watts. The two layer stacks are twisted around one another substantially in an S shape, run parallel to each other (with constant gaps relative to each other), span the flow cross section of the exhaust gas uniformly and are disposed (only) in a common cylindrical volume.

Other features which are considered as characteristic for the invention are set forth in the appended claims, noting that the features presented separately in the dependent claims can be combined in any technologically meaningful way and define additional embodiments of the invention.

Although the invention is illustrated and described herein as embodied in a honeycomb body heatable in multiple stages, a method for heating a honeycomb body and a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, end-elevational, first view of a heatable honeycomb body;

FIG. 2 is a longitudinal-sectional, second view of the heatable honeycomb body;

FIG. 3 is an enlarged, fragmentary, end-elevational view of layers of a heating disk; and

FIG. 4 is a plan view of a motor vehicle having a honeycomb body according to the invention.

### DETAILED DESCRIPTION OF THE INVENTION

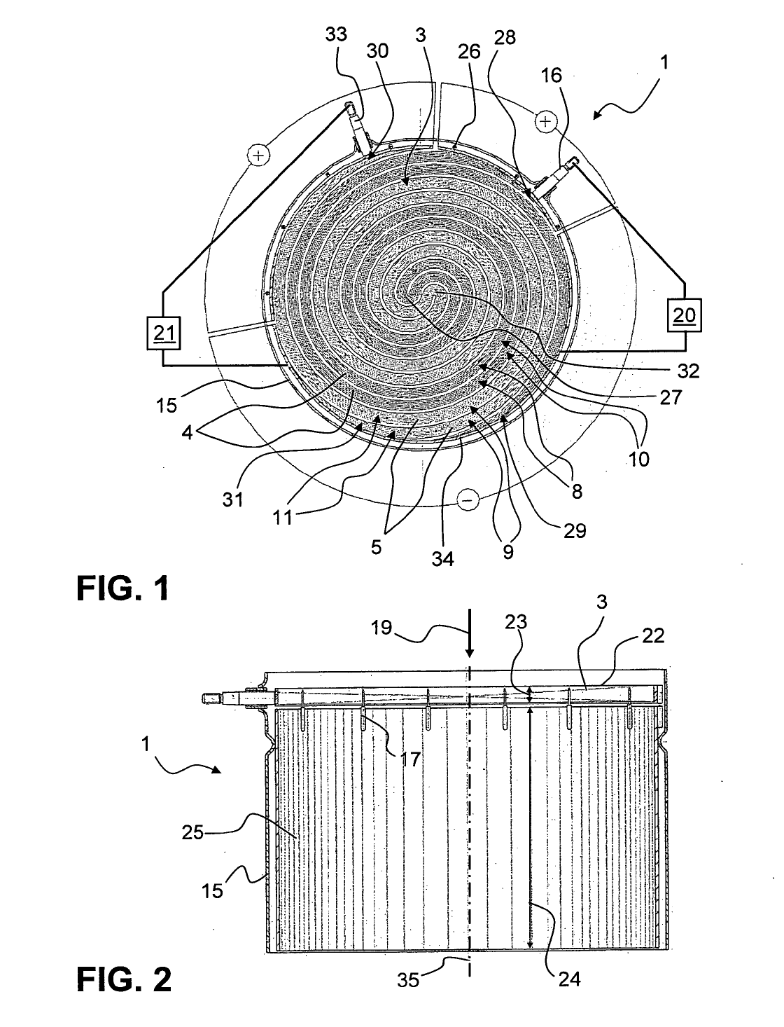

Referring now in detail to the figures of the drawing for explaining the invention and the technical field in more detail by showing particularly preferred structural variants to which the invention is not restricted, and first, particularly, to FIG. 1 thereof, there is shown a honeycomb body 1 as seen from an exhaust gas inflow direction 19 (indicated in FIG. 2). This honeycomb body 1 has a housing 15 with a first positively polarized electrode 16, a second positively polarized electrode 33 and a negatively polarized electrode 34. The first positively polarized electrode 16, second positively polarized electrode 33 and negatively polarized electrode 34 are electrically insulated from the housing 15 and the structure thereof is principally known from the prior art.

A heating disk 3 is disposed in this housing 15, in a position substantially coaxial with the housing 15, and is spaced apart and electrically insulated from the housing 15 with the aid of spacers 26. The heating disk 3 is formed from a first layer stack 4 and a second layer stack 5, which are twisted around one another in an S shape. The first layer stack 4 has a first fold 27, and the second layer stack 5 has a second fold 32. The first layer stack 4 is folded around this first fold 27 and the second layer stack 5 is folded around this second fold 32. The first fold 27 and the second fold 32 extend substantially parallel to a center line 35 (indicated in FIG. 2) of the honeycomb body 1. Two fold arms of the first layer stack 4 and of the second layer stack 5 extend from the first fold 27 of the first layer stack 4 and the second fold 32 of the second layer stack 5. The arms are (electrically) connected to each other in the region of the first fold 27 and the second fold 32 but are otherwise electrically insulated from each other, in this case by an air gap.

The opposite ends of the fold arms from the first fold 27 of the first layer stack 4 are connected in an electrically conductive manner to the first positively polarized electrode 16 and the negatively polarized electrode 34. The opposite ends of the fold arms from the second fold 32 of the second layer stack 5 are connected in an electrically conductive manner to the second positively polarized electrode 33 and the negatively polarized electrode 34. The first layer stack 4 thus forms a first current path 8, which extends from a first current path start 28 in the region of contact with the first positively poled electrode 16, through the first fold 27 of the first layer stack 4, to a first current path end 29 in the region of contact with the negatively poled electrode 34. The second layer stack 5 forms a second current path 9, which extends from a second current path start 30 in the region of contact with the second positively poled electrode 33, through the second fold 32, to a second current path end 31 in the region of contact of the negatively poled electrode 34. It should be made clear in this case that the first layer stack 4 is electrically insulated from the second layer stack 5, in this case by an air gap. The first positively polarized electrode 16 and the negatively polarized electrode 34, which make contact with the first layer stack 4, are connected in an electrically conductive manner to a first current source 20, and a first heating circuit 10 is thus formed in the first layer stack 4. The second positively polarized electrode 33 and the negatively polarized electrode 34, which make contact with the second layer stack 5, are connected in an electrically conductive manner to a second current source 21, and a second heating circuit 11 is thus formed in the second layer stack 5.

FIG. 2 shows the heatable honeycomb body 1 in section from the side. The figure illustrates a support catalytic converter 25 with a support catalytic converter height 24. A heating disk 3 with a heating disk height 23 is secured on this support catalytic converter 25 against the inflow direction 19 of the exhaust gas with the aid of support pins 17. This heating disk 3 has a front face 22, through which the exhaust gas enters the heatable honeycomb body 1 in the inflow direction 19.

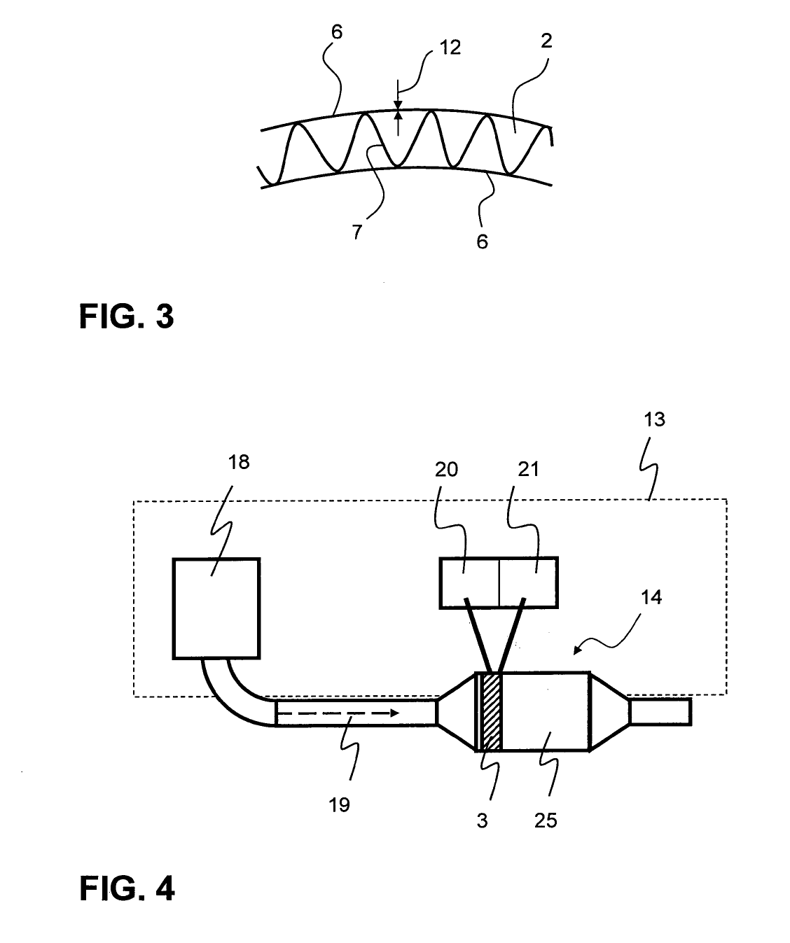

FIG. 3 shows two smooth layers 6 and a structured layer 7, with which the first layer stack 4 and the second layer stack 5 can be constructed, as an example. These smooth layers 6 and structured layer 7 form channels 2 through which exhaust gas can flow. In this case, the smooth layers 6 and the structured layer 7 have a layer thickness 12.

FIG. 4 shows a motor vehicle 13 having an internal combustion engine 18, with a support catalytic converter 25 of an electrically heatable honeycomb body 1 according to the invention disposed in an exhaust system 14 of the internal combustion engine 18. The inflow direction 19 in the exhaust system 14 as well as the current sources 20, 21 connected to the heating disk 3, can also be seen.

In this way, the exhaust gas from an internal combustion engine can be uniformly heated by a plurality of independent heating circuits in a common heating disk, even with different heating powers, using a simple construction.

1. An electrically heatable honeycomb body, comprising:
at least one heating disk having channels, at least one first layer stack of an electrically conductive material and at least one second layer stack of an electrically conductive material;
said first layer stack and said second layer stack being twisted with each other and electrically insulated from each other;
said first layer stack forming a first current path for conducting an electrical current in a first heating circuit and said second layer stack forming a second current path for conducting an electrical current in a second heating circuit.

2. The electrically heatable honeycomb body according to claim 1, wherein said first layer stack and said second layer stack each have layers, and said layers of said first layer stack and said second layer stack have different thicknesses.

3. The electrically heatable honeycomb body according to claim 2, wherein said layer thicknesses of said layers of said first layer stack are 25 μm to 35 μm and said layer thicknesses of said layers of said second layer stack are 35 μm to 65 μm.

4. The electrically heatable honeycomb body according to claim 2, wherein said first layer stack and said second layer stack have different number of said layers.

5. The electrically heatable honeycomb body according to claim 2, wherein said first layer stack and said second layer stack have at least different structures or coatings.

6. A method for heating a honeycomb body, the method comprising the following steps:
providing the at least one heating disk according to claim 1;
operating the first heating circuit of the at least one heating disk with a power of 300 W to 500 W; and
operating the second heating circuit of the at least one heating disk with a power of 500 W to 700 W.

7. A motor vehicle, comprising:
at least one electrically heatable honeycomb body with at least one heating disk according to claim 1;
said first heating circuit of said at least one heating disk being configured for operating with a power of 300 W to 500 W; and
said second heating circuit of said at least one heating disk being configured for operating with a power of 500 W to 700 W.
